(19) United States
(12) Patent Application Publication
(10) Pub. No.: US 2006/0124806 A1
(43) Pub. Date: Jun. 15, 2006

(54) Device for convenient retention and storage of an audio/video component remote control unit

(76) Inventor: William J. Crowther, Napa, CA (US)

Correspondence Address: STEPHEN M. NIPPER;DYKAS, SHAVER & NIPPER, LLP, PO BOX 877, BOISE, ID, 83701-0877, US

(21) Appl. No.: 11/010,218

(22) Filed: Dec. 10, 2004

(51) Int. Cl. H02P 1/00; H04Q 7/00

(52) U.S. Cl. 248/139

(57) ABSTRACT

A device for convenient retention and storage of an audio/video component remote control unit. The device for attaching the remote control unit to a surface. The device having a cradle for receiving therein the audio/video component remote control unit and a cord extending therefrom for attaching to the remote control unit.

### BACKGROUND OF THE INVENTION

1. Field of the Invention

The present invention generally relates to storage devices, and more particularly relates to devices for retaining and storing remote control units for audio/video components.

2. Background Information

Ever since the first audio/video component remote control unit was invented by Dr. Robert Adler in 1958, one of the biggest complaints and/or drawbacks of the use of remote control units is their tendency to become misplaced and/or lost. Many audio/video components rely heavily upon the use of the remote control unit for operation, often rendering the component nearly useless without a functional remote control unit. Additionally, the time spent searching for misplaced remote control units completely defeats the purpose of having the remote control in the first place, namely the convenience of not needing to get up from one's chair.

Remote control owners have recognized this problem and inventors have answered with numerous solutions to the problem. As can be seen from a review of prior patents, shown are many different patented devices for retaining and/or protecting remote control units. For instance, U.S. Pat No. 5,195,634 to Zaug discloses a remote control holder comprising a closeable box for protecting the remote control unit, the remote control unit attaches to the closeable box through use of a cord.

A second patent, U.S. Pat. No. 5,316,249 to Anderson disclosed a stand with a tether for electronic remote control units. The Anderson stand has a body for supporting the remote control unit which extends from the body by a cord that attaches to the remote control unit.

Referring now to U.S. Pat. No. 5,460,347 to Schacher, shown is a tethering device comprising a loop for attachment to a remote control unit that extends via a cord to a clip for clipping the cord to a surface such as a couch cushion.

Finally, U.S. Pat. No. D412,706 to Virost shows a design of a remote control tether for tethering a remote control to a surface.

What is needed is a device for convenient retention and storage of an audio/video component remote control unit. Embodiments of the present invention solve this need.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

One embodiment of the present invention is a device for convenient retention and storage of an audio/video component remote control unit. This device is configured for attaching the remote control unit to a surface. The device itself comprises a cradle, a cord and a remote attachment.

The cradle is for storing the remote control unit when the remote control unit is not in use. The cradle has a bottom side and an open first end. The bottom side is configured for attachment to the surface, preferably through use of a piece of double sided tape. The open first end is configured for receiving at least a portion of the remote control unit therein. The cradle is further configured for attachment to a cord. In the preferred embodiment a loop extends from the side of the cradle for this purpose.

The cord interconnects the remote attachment to the cradle. The cord has a first end extending to a second end. The first end is configured for attachment to the cradle at a cradle loop. The second end is configured for attachment to the remote attachment. It is preferred that the cradle loop attach to the cord through use of a first metal ring loop through both the cradle loop and a cord loop. It is preferred that the cord be helical wound plastic cord configured for automatic shortening after being extended. The cord second end comprises a second end cord loop that is configured for receiving therethrough a second metal ring, this second metal ring is configured for attachment to a latch. It is preferred that this latch be configured for cooperating with the remote attachment, preferably releasably so.

Finally, the remote attachment is for attaching the cord to the remote control unit itself. The remote attachment is configured for releasable attachment to the remote control unit so that the remote control unit can be detached from the remote attachment or at least a portion thereof. The remote attachment comprises a body for mounting on said remote control and a third ring. This third ring allows for a flexible pivoting attachment between the cord and the remote control unit. The latch is preferably configured for latching onto this third ring. It is preferred that the remote attachment attach to the remote control unit through use of double sided adhesive tape.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 shows a perspective view of one embodiment of the present invention.

FIG. 2A shows a bottom view of FIG. 1.

FIG. 2B shows a close up view of the portion of FIG. 2A.

FIG. 3 shows a close up view of one embodiment of a remote attachment of the present invention.

FIG. 4 shows one embodiment of a cord of the present invention.

FIG. 5A shows a side view of one embodiment of a latch of the present invention.

FIG. 5B shows a second side view of the embodiment of FIG. 5A.

FIG. 5C shows a perspective view of the embodiment of FIG. 5A.

FIG. 6 shows a perspective view of another embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

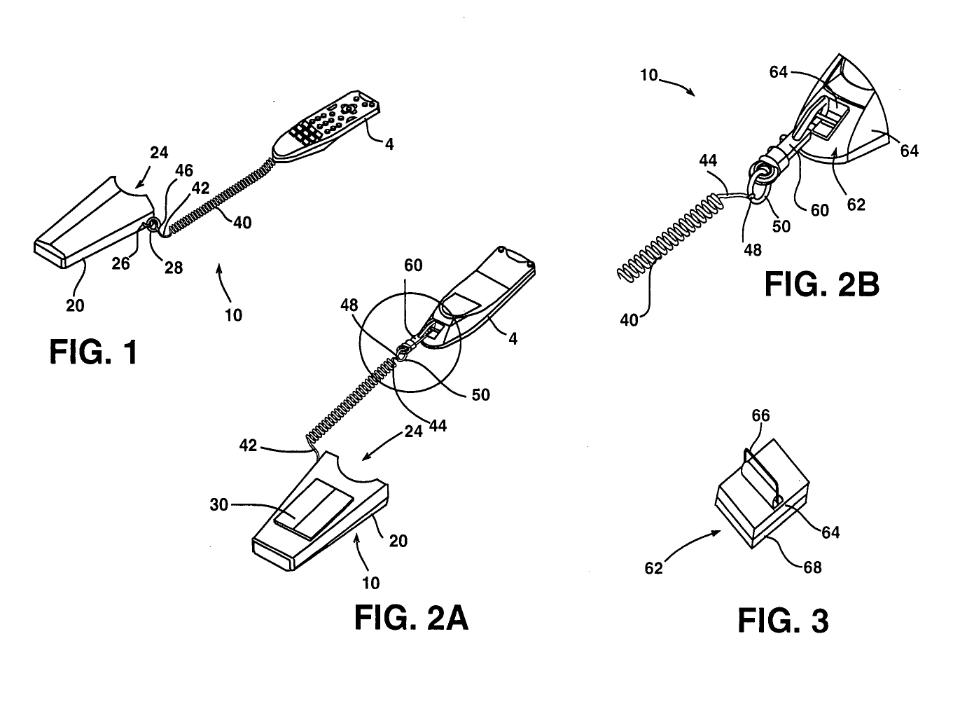

Referring initially to FIG. 1, shown is one embodiment of the present invention. The present invention comprises a device for convenient retention and storage of an audio/video component remote control unit or “device 10.” While the present invention is envisioned for attachment to an audio/video component remote control (such as a television set remote control, an audio receiver remote control, a VCR player remote control, a DVD player remote control, a digital video recorder remote control, etc.), the present invention could likewise have other uses other than with respect to a “remote control.” This disclosure, in talking about the preferred embodiment being used to retain a remote control unit, is not intended as being a limitation on the use of the present invention.

Referring to FIG. 1, FIG. 2A and FIG. 2B, shown is one embodiment of the present invention. The device 10 having a cradle 20 providing a storage and protection location for the remote control unit 4 when not in use and a cord 40 for interconnecting the cradle 20 to the remote control unit 4. While other embodiments may have more or less elements, this is the configuration of the preferred embodiment of the present invention.

The cradle 20 preferably having a bottom side 22 which is configured for attachment to a surface such as a sofa arm or a coffee table, etc. Preferably a piece or pieces of double sided adhesive tape 36 are used for this attachment. However, there are other manners of attaching the cradle to the surface that are envisioned including, but not limited to hook-and-loop style fasteners, adhesives, fasteners, mechanical means, etc. While it is preferred that the bottom side be configured for attachment, obviously other sides or portions of the cradle could serve this purpose. The cradle 20 having an open first end 24 which is configured for receiving therein at least a portion of the remote control unit 4 (as shown in FIG. 6). It is preferred that the cradle be elongated as a remote control unit is, said cradle having a general elongate internal recess configured for receiving therein the generally elongate remote control unit.

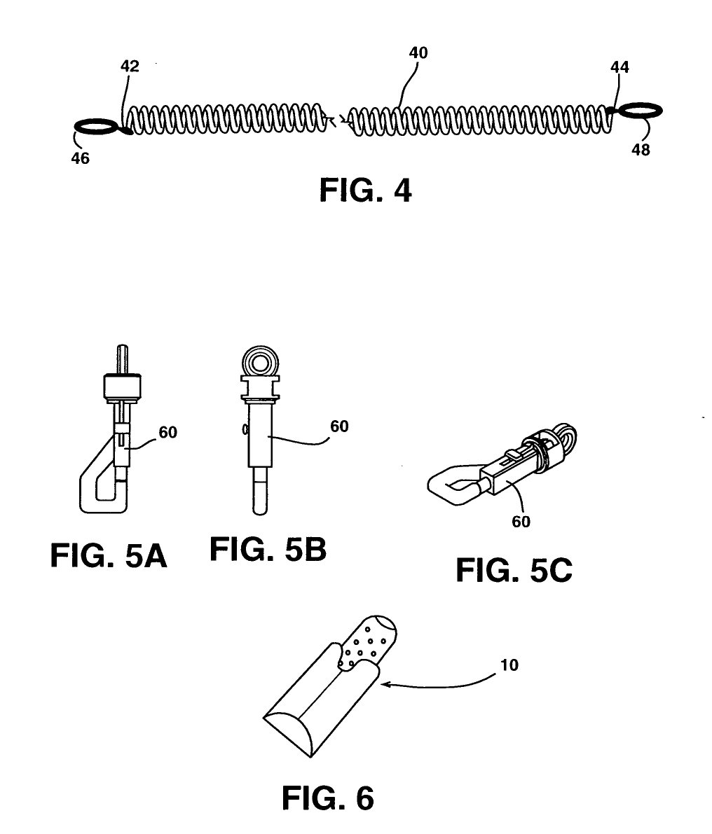

It is preferred that the cradle 20 be configured for attaching to the cord 40. Various means can be used to do this including, but not limited to hook-and-loop style fasteners, adhesives, fasteners, mechanical means, etc. In a preferred embodiment, an extension or cradle loop 26 extends from the side of the cradle 20. This cradle loop 26 is configured for cooperating with a first metal ring 28, the metal ring 28 looping through the cradle loop 26. It is preferred that the cord 40 have a cord first end 42 extending to a cord second end 44 (as shown in FIG. 4).

In the embodiment shown, the cord first end 42 comprises a first end cord loop 46 whereas the cord second end 44 comprises a second end cord loop 48. The first end cord loop 46 configured for receipt therethrough the first metal ring 28 thereby attaching the cradle 20 to the cord 40.

In the preferred embodiment, it is preferred that the second end cord loop 48 be configured for attachment through use of a second metal ring 50 to a latch 60. While the cord second end 44 could directly attach to the body (third) ring 66 of the remote attachment, it is preferred that a latch 60 be used so the remote control unit 4 can be detached from the cord 40 when so desired by the user. For instance, when the user wants to use the remote control in another location, etc. This latch 60 preferably having a manually operated clasp for allowing the latch to be attached and detached from the third ring 66. One embodiment of such a latch 60 is shown in FIGS. 5A, 5B and 5C.

It is preferred that a remote attachment 62 be configured for attachment to the remote control unit 4 as particularly shown in FIG. 2B. In this embodiment the remote attachment 62 comprises a body 64 with a third ring 66 pivotally attaching thereto, this body attaching to the remote control unit 4 through use of double sided adhesive tape 68. While double sided adhesive tape is envisioned as the preferred manner of attaching these two components together, it is likewise envisioned that other manners, such as hook-and-loop style fasteners, adhesives, fasteners, etc. could likewise be used.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A device for convenient retention and storage of an audio/video component remote control unit, said device for attaching said remote control unit to a surface, said device comprising:
a cradle for storing said remote control unit when said remote control unit is not in use, said cradle comprising a bottom side and an open first end, said bottom side configured for attachment to said surface, said open first end configured for receiving a portion of said remote control unit therein, said cradle configured for attachment to a cord; and
a cord for interconnecting said remote control to said cradle, said cord having a first end extending to a second end, said first end configured for attachment to said cradle, said second end configured for attachment to said remote control unit.

2. The device of claim 1, wherein said cradle attaches to said surface through use of a double-sided adhesive tape.

3. The device of claim 1, wherein said cradle further comprises a cradle loop extending therefrom, said cradle loop configured for attachment to said cord.

4. The device of claim 3, wherein said cradle loop attaches to said cord through use of a first metal ring looped through said cradle loop and attaching to said cord first end.

5. The device of claim 4, wherein said cord first end comprises a first end cord loop, said first end cord loop configured for receiving therethrough said first metal ring.

6. The device of claim 1, wherein said cord comprises a helical wound plastic cord configured for automatic shortening after being extended.

7. The device of claim 1, wherein said cord second end comprises a second end cord loop, said second end cord loop configured for receiving therethrough a second metal ring.

8. The device of claim 7, wherein said cord second metal ring is configured for attachment to a latch.

9. The device of claim 8, wherein said latch is configured for cooperating with a remote attachment attached to said remote control unit.

10. The device of claim 9, wherein said remote attachment comprising a body for mounting upon said remote control unit and third ring, said latch configured for latching onto said third ring.

11. The device of claim 10, wherein said remote attachment attaches to said remote control unit through use of double sided adhesive tape.

12. A device for convenient retention and storage of an audio/video component remote control unit, said device for attaching said remote control unit to a surface, said device comprising:
a cradle for storing said remote control unit when said remote control unit is not in use, said cradle comprising a bottom side and an open first end, said bottom side configured for attachment to said surface, said open first end configured for receiving a portion of said remote control unit therein, said cradle configured for attachment to a cord; and
a cord for interconnecting a remote attachment to said cradle, said cord having a first end extending to a second end, said first end configured for attachment to said cradle, said second end configured for attachment to said remote attachment;
a remote attachment for attaching said cord to said remote control unit, said remote attachment configured for releasable attachment to said remote control unit so said remote control unit can be detached from said remote attachment.

13. The device of claim 12, wherein said cradle attaches to said surface through use of a double-sided adhesive tape.

14. The device of claim 12, wherein said cradle further comprises a cradle loop extending therefrom, said cradle loop configured for attachment to said cord.

15. The device of claim 14, wherein said cradle loop attaches to said cord through use of a first metal ring looped through said cradle loop and attaching to said cord first end.

16. The device of claim 15, wherein said cord first end comprises a first end cord loop, said first end cord loop configured for receiving therethrough said first metal ring.

17. The device of claim 12, wherein said cord comprises a helical wound plastic cord configured for automatic shortening after being extended.

18. The device of claim 12, wherein said cord second end comprises a second end cord loop, said second end cord loop configured for receiving therethrough a second metal ring.

19. The device of claim 18, wherein said cord second metal ring is configured for attachment to a latch, wherein said latch is configured for cooperating with a remote attachment attached to said remote control unit, wherein said remote attachment comprising a body for mounting on said remote control unit and third ring, said latch configured for latching onto said third ring, and wherein said remote attachment attaches to said remote control unit through use of double-sided adhesive tape.

20. A device for convenient retention and storage of an audio/video component remote control unit, said device for attaching said remote control unit to a surface, said device comprising:
a cradle for storing said remote control unit when said remote control unit is not in use, said cradle comprising a bottom side and an open first end, said bottom side configured for attachment to said surface, said open first end configured for receiving a portion of said remote control unit therein, said cradle configured for attachment to a cord, wherein said cradle further comprises a cradle loop extending therefrom; and
a cord for interconnecting a remote attachment to said cradle, said cord having a first end extending to a second end, said first end configured for attachment to said cradle, said second end configured for attachment to said remote attachment, wherein said cradle loop attaches to said cord through use of a first metal ring looped through said cradle loop and attaching to said cord first end, wherein said cord first end comprises a first end cord loop, said first end cord loop configured for receiving therethrough said first metal ring, wherein said cord comprises a helical wound plastic cord configured for automatic shortening after being extended, wherein said cord second end comprises a second end cord loop, said second end cord loop configured for receiving therethrough a second metal ring, wherein said cord second metal ring is configured for attachment to a latch, wherein said latch is configured for cooperating with a remote attachment;
a remote attachment for attaching said cord to said remote control unit, said remote attachment configured for releasable attachment to said remote control unit so said remote control unit can be detached from said remote attachment, wherein said remote attachment comprises a body for mounting on said remote control unit and third ring, said latch configured for latching onto said third ring, and wherein said remote attachment attaches to said remote control unit through use of double sided adhesive tape.
